(19) United States
(12) Patent Application Publication
(10) Pub. No.: US 2013/0255155 A1
(43) Pub. Date: Oct. 3, 2013

(54) COVER ASSEMBLY AND ELECTRONIC DEVICE USING THE SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: XUE-DONG TANG, Shenzhen (CN); WEI LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/797,807

(22) Filed: Mar. 12, 2013

(30) Foreign Application Priority Data
Mar. 29, 2012 (CN) 201210087698.6

(51) Int. Cl. E05D 7/00; E06B 3/34

(52) U.S. Cl. CPC E05D 7/00; E06B 3/34
USPC 49/67

(57) ABSTRACT

A cover assembly includes a base including an opening, a first hole and a second hole, an elastic cover including a first pivot and a second pivot coaxially aligned with the first pivot. The first pivot is rotatably received in the first hole and the second pivot is rotatably received in the second hole, thereby rotatably connecting the cover to the base. The cover is rotatable between a closed position where the cover covers the opening, and an open position where the opening is exposed. The operator only needs to bend the cover slightly, and assembles the first pivot and the second pivot into the pair of holes from the opening respectively.

### BACKGROUND

1. Technical Field

The present disclosure relates to cover assemblies, and particularly to a cover assembly serving as a front panel of an optical disc playing device.

2. Description of Related Art

Digital Versatile Disc (DVD) players, computers or other electronic device often have a built-in optical drive such as a CD-ROM, a DVD-ROM, a CDRW and a DVDRW CD-ROM. In order to be able to use optical drives such as a DVD, a DVD-ROM, a CDRW and a DVDRW CD-ROMs and harmonize the entire appearance of the electronic device, it is necessary to cover the optical drive yet still allowing the drive to be able to open.

Usually, a cover assembly is arranged to cover the optical drive, the cover assembly includes a door and a rotation axis including a torsion spring. The rotation axis is accommodated in a shell of the electronic device, the door is fixed on the rotation axis by bolts and capable of rotating together with the rotation axis. During assembly, the rotation axis is accommodated in a shell, but the door must be assembled from the outside of the shell, and the operator must screw the bolts in the inside of the shell to fix the door on the rotation axis, which is complicated. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of a cover assembly in an open state in accordance with an exemplary embodiment.

FIG. 2 is an assembled, isometric view of the cover assembly of FIG. 1 in a closed state.

FIG. 3 is schematic view showing a door of the cover assembly of FIG. 1.

FIG. 4 is a schematic view showing a base of the cover assembly of FIG. 1.

FIG. 5 is a schematic, rear view of the cover assembly of FIG. 1.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean at least one.

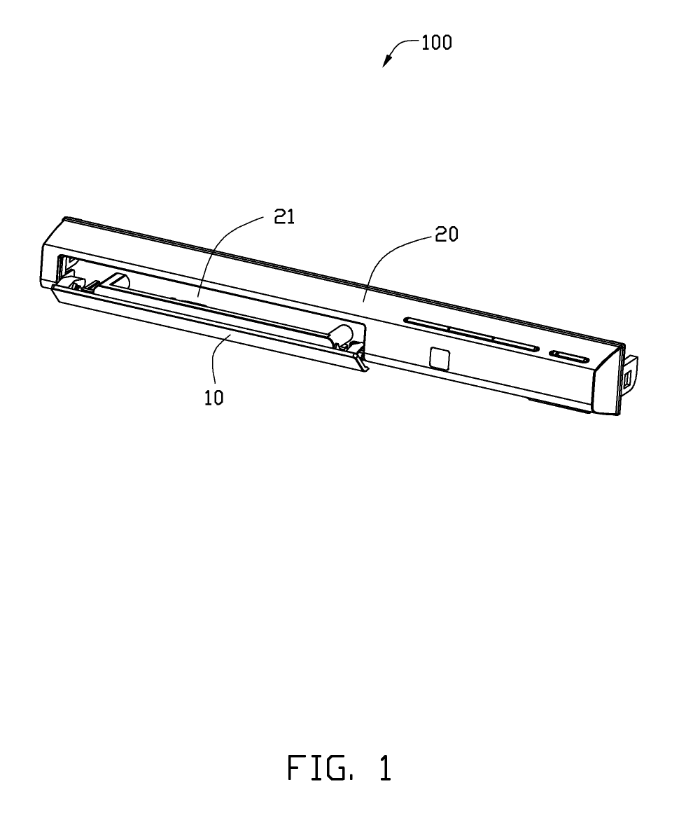

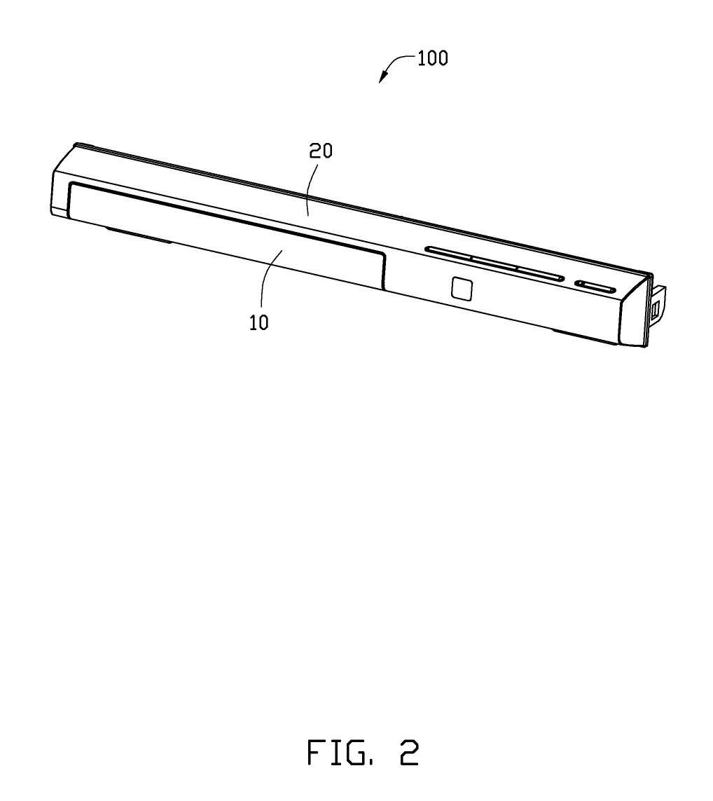

Referring to FIGS. 1 and 2, a cover assembly 100 of an electronic device is illustrated. The cover assembly 100 includes a rotatable cover 10 and a base 20. A rectangle opening 21 is defined in the base 20, and the cover 10 is rotatably connected to the base 20 and covers the opening 21 when closed. In one embodiment, the cover assembly 100 can be used in an optical disc playing device (not shown) and serves as a front panel. The disc tray (not shown) of the disc playing device that is used to support an optical disc (not shown) can move out through the opening 21.

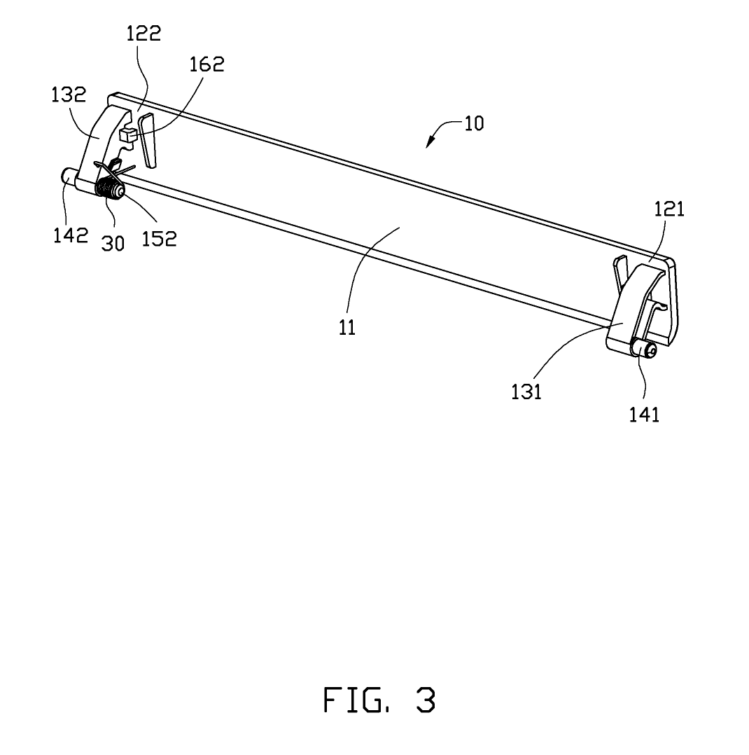

Referring to FIG. 3, the cover 10 includes a panel 11, a first end 121, and a second end 122 opposite to the first end 121. A first arm 131 protrudes from an inner surface (not labeled) of the panel 11 close to the first end 121, and a second arm 132 protrudes from an inner surface (not labeled) of the panel 11 close to the second end 122. A first pivot 141 protrudes outwardly from one side of the first arm 131 and extends in a direction parallel to the lengthwise direction of the panel 11. A second pivot 142 protrudes outwardly from one side of the second arm 132 and extends in a direction parallel to the lengthwise direction of the panel 11. The first pivot 141 and the second pivot 142 extend substantially in a straight line and in opposite directions. The second arm 132 further includes a protruding post 152 and a first holder 162 on an inner side of the second arm 132 which is opposite to the side where the second pivot 142 protrudes from. In the embodiment, the cover 10 is made of elastic material, such as, elastic plastic.

The cover assembly 100 further includes a torsion spring 30 including a first torsion arm 31 and a second torsion arm 32. The torsion spring 30 is coiled around the protruding post 152, and the first torsion arm 31 is held by the first holder 162.

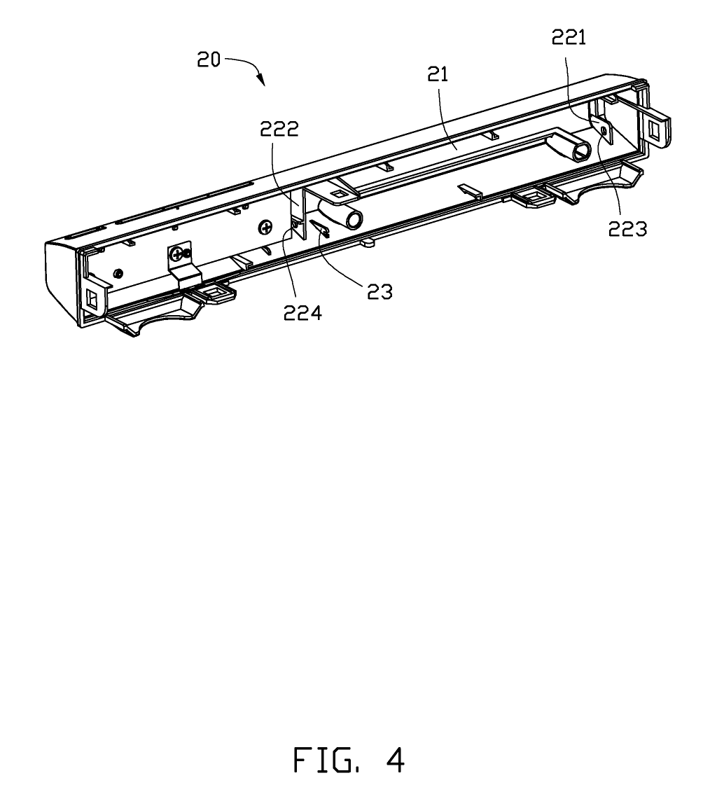

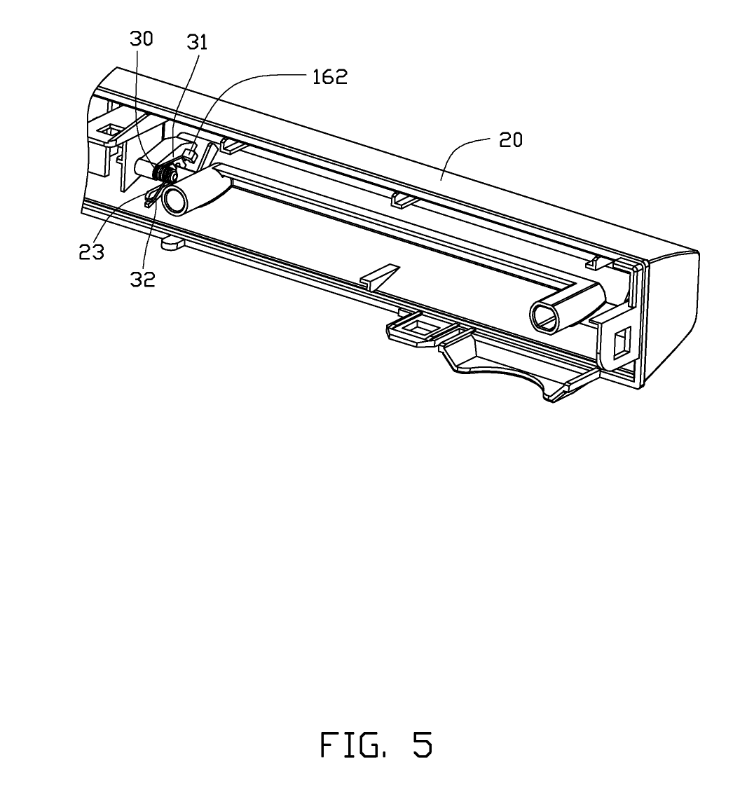

Referring to FIGS. 4 and 5, the base 20 includes a first internal wall 221 and a second internal wall 222 protruding inwardly from opposite ends of the opening 21. A first hole 223 is defined in the first internal wall 221, and a second hole 224 is defined in the second internal wall 222. The first pivot 141 is rotatably received in the first hole 223, and the second pivot 142 is rotatably received in the second hole 224. Because the second pivot 142 is coaxially aligned with the first pivot 141, the cover 10 is capable of pivoting about the first pivot 141 and/or the second pivot 142.

The base 20 further includes a second holder 23 arranged in the inner side of the base 20, and the second torsion arm 32 is held by the second holder 23. The torsion spring 30 applies a pulling force to the cover 10.

When the cover 10 is pushed by the disc tray, the cover 10 pivots about the first pivot 141 and the second pivot 142 until the disc tray moves out from the opening 21. When the disc tray moves back, the cover 10 rotates back to its original position under the pulling force of the torsion spring 30.

In other embodiments, the first pivot 141 extends from the first end 121 instead of extending from the first arm 131, similarly, the second pivot 142 extends from the second end 122.

Because the cover 10 is made of elastic material, during assembly, the operator only needs to bend the cover 10 slightly, and assembles the first pivot 141 into the hole 223, and the second pivot 142 into the hole 224 from the opening 21. The operator does not need to screw the bolts in the inside of the base 20 to fix the cover 10. In this way, the assembly process is greatly simplified.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A cover assembly comprising:
a base defining an opening, a first hole and a second hole;
an elastic cover comprising a first pivot and a second pivot coaxially aligned with the first pivot, the first pivot being rotatably received in the first hole and the second pivot being rotatably received in the second hole, thereby rotatably connecting the cover to the base; the cover being rotatable between a closed position where the cover covers the opening, and an open position where the opening is exposed.

2. The cover assembly of claim 1, wherein the base comprises a first internal wall and a second internal wall at opposite ends of the opening, the first hole is defined in the first internal wall, and the second hole is defined in the second internal wall.

3. The cover assembly of claim 1, wherein the cover comprises a first end and a second end opposite to the first end, the first pivot protrudes outwardly from the first end and extends in a direction parallel to the lengthwise direction of the cover, the second pivot protrudes outwardly from the second end and extends in a direction parallel to the lengthwise direction of the cover.

4. The cover assembly of claim 3, wherein a first arm protrudes from the first end, and a second arm protrudes from the second end; the first pivot protrudes outwardly from one side of the first arm end, and the second pivot protrudes outwardly from one side of the second arm end.

5. The cover assembly of claim 3, wherein the cover assembly further comprises a torsion spring comprising a torsion first arm and a second torsion arm, the second arm comprises a protruding post and a first holder, the base comprises a second holder; the torsion spring is coiled around the protruding post, the first torsion arm is held by the first holder and the second arm is held by the second holder, the torsion spring is configured to apply a pulling force to the cover.

6. An electronic device with a cover assembly comprising:
a shell defining an opening, a first hole and a second hole;
an elastic cover comprising a first pivot and a second pivot coaxially aligned with the first pivot, the first pivot being rotatably received in the first hole and the second pivot being rotatably received in the second hole, thereby rotatably connecting the cover to the base; the cover being rotatable between a closed position where the cover covers the opening, and an open position where the opening is exposed.

7. The electronic device of claim 6, wherein the base comprises a first internal wall and a second internal wall at opposite ends of the opening, the first hole is defined in the first internal wall, and the second hole is defined in the second internal wall.

8. The cover assembly of claim 6, wherein the cover comprises a first end and a second end opposite to the first end; the first pivot protrudes outwardly from the first end and extends in a direction parallel to the lengthwise direction of the cover, the second pivot protrudes outwardly from the second end and extends in a direction parallel to the lengthwise direction of the cover.

9. The cover assembly of claim 7, wherein a first arm protrudes from the first end, and a second arm protrudes from the second end; the first pivot protrudes outwardly from one side of the first arm end, and the second pivot protrudes outwardly from one side of the second arm end.

10. The cover assembly of claim 7, wherein the cover assembly further comprises a torsion spring comprising a torsion first arm and a second torsion arm, the second arm comprises a protruding post and a first holder, the base comprises a second holder; the torsion spring is coiled around the protruding post, the first torsion arm is held by the first holder and the second arm is held by the second holder, the torsion spring is configured to apply a pulling force to the cover.
